(19) United States
(12) Patent Application Publication
(10) Pub. No.: US 2007/0288946 A1
(43) Pub. Date: Dec. 13, 2007

(54) METHOD AND APPARATUS FOR DISCRIMINATING DISCS

(76) Inventors: Ching-Hung Chang, Taoyuan (TW); Wen-Kuan Peng, Taoyuan (TW)

Correspondence Address: G. LINK CO., LTD., 3550 BELL ROAD, MINOOKA, IL, 60447, US

(21) Appl. No.: 11/423,465

(22) Filed: Jun. 12, 2006

(51) Int. Cl. G11B 17/04

(52) U.S. Cl. 720/626; 720/645; 720/625

(57) ABSTRACT

A method and apparatus for discriminating discs includes a loading mechanism transporting discs at an entrance of a disc drive. A sensor unit close to the loading mechanism starts or stops the loading mechanism according to the detection. The center of the receptor disposes a limiting pin to limit the moving distance of the receptor based on the disc size discriminated by the sensor unit. Two ends of a receptor dispose two symmetric positioning posts for positioning automatically. The disc size can be discriminated by counting sensors on for judging increases or decreases, and counting loading time for comparing with the predetermined time.

### FIELD OF THE INVENTION

The invention is related to a method for loading and ejecting a disc in a disc drive, and more particularly, to a method and apparatus for discriminating the disc size and selecting the proper disc in a disc drive with slot-loading mechanism.

### BACKGROUND OF THE INVENTION

Discs mainly come in with standard 8 cm and 12 cm diameter sizes, thus the loading mechanism of the conventional disc drive is generally designed for both sizes for consumers' convenience. The conventional slot-loading disc drive 10 is taken as a case as shown in FIG 1. The slot-loading disc drive 10 includes a cone-and-stick shaped roller 12 disposed at the entrance 11, a first sensor 13a disposed before the roller 12, and a second sensor 13b disposed after the roller 12 respectively. When the first sensor 13a detects the loaded disc 14, the roller 12 rolls accordingly to draw the loaded disc 14 into the disc drive 10, and the symmetric positioning posts 15a and 15b of the receptor 15 are used to support the peripheral edge of the disc 14 so as to make the center of the disc 14 to be positioned to the central line of the spindle motor 16 automatically Then, driven by the roller 12, the receptor 15 slides along the parallel runners 17a and 17b via the center positioning pin and the center positioning posts 15a and 15b, and transport the center of the disc 14 to the spindle motor 16 so as to make the spindle motor 16 rotate the disc 14, then the positioning is completed. Besides, the roller 12 rolls reversely when the disc is to be ejected, so that the disc 14 is withdrawn from the disc drive 10. When the disc 14 leaves the second sensor 13b, the roller 12 stops rotating so as to make the disc 14 stay at the entrance 11 for being taken away.

The position of the center of the disc 14 changes according to the varying sizes of the disc 14, and the moving distance of the receptor 15 changes accordingly for adjustment, otherwise the disc 14, which is not positioned, will be pressed and damaged. Thus a selecting pole 18 is disposed at the side, and a selective coactive starting arm 19 is disposed at the back in a conventional disc drive as an apparatus for discriminating discs. The disc with 8 cm diameter 14a is relatively smaller in size, consequently when it is drawn into the disc drive, the selecting pole 18 will not be touched, and the starting arm 19 will maintain its original position. During transporting the disc 14, the projected pin 15c of the receptor 15 slides in the strip slot 19a of the starting arm 19, and moves along the runner 17c, so that the starting arm 19 is linked and guided to rotate around the supporting axis 19b lodged in the moving slot 101 to make the limited pin 19c on the starting arm 19 move along the small slot side 102a of the cam slot 102, and limit the moving distance of the receptor 15 at the same time, and thus the disc with 8 cm diameter 14a is moved to position.

As shown in FIG. 2, when the disc with 12 cm diameter 14b is drawn into the disc drive, the disc with the longer diameter will touch the front part 18a of the selecting pole 18, and the selecting pole 18 will rotate around the supporting point 18b so as to make the back 18c of the pole 18 push the selecting arm 19, accordingly the supporting axis 19b moves inwards along the moving slot 101, and the limited pin 19c goes into the big slot of the cam slot 102 at the same time. During transporting the disc 14, the projected pin 15c of the receptor 15 slides in the strip slot 19a of the starting arm 19, and moves along the runner 17c, so that the starting arm 19 is linked and guided to rotate around the supporting axis 19b to make the limited pin 19c move along the big slot side 102b of the cam slot 102, and the receptor 15 moves a relatively long distance, and thus the disc with 12 cm diameter 14b is moved to position.

A multi-linkage mechanism is used in the conventional disc drive 10 to discriminate the disc size which can complete the loading and ejecting operations of discs with 8 cm diameter and 12 cm diameter. However, the front part 18a of the selecting pole 18 at the entrance is more easily touched by the loaded disc with 8 cm diameter sideways, which may cause wrong operations and then damage the disc. Besides, the multi-linkage mechanism needs enough height for piling up, which makes it impossible to decrease the thickness of discs. Moreover, a plethora of the multi-linkage mechanism elements, the high cost price, and the complicated and time-consuming production and assembly are the disadvantages of a conventional disc drive. Therefore, there are still problems with the method for focusing adjustment of the conventional disc loading mechanism remaining to be solved.

### SUMMARY OF THE INVENTION

One objective of the present invention is to provide a method and apparatus for discriminating discs, which includes a sensor unit for detecting the loading time of discs to discriminate the disc size, so that the disc drive can be made thinner, the cost price of elements can be lowered, and the efficiency of the production and the assembly can be promoted.

The second objective of the invention is to provide a method and apparatus for discriminating discs that uses a sensor unit to detect the number changing when a disc is inserted into the disc drive and then discriminate the disc size, so that the reliability for discriminating the disc size can be promoted and the discs can be protected.

Another objective of the invention is to provide a method and apparatus for discriminating discs that uses a sensor unit to identify the disc size and then select a disc suitable for quick use, so that the efficiency of disc drive can be promoted.

The other objective of the invention is to provide a method and apparatus for discriminating discs that uses a sensor unit to identify and reject non-disc objects and protect the disc drive.

To obtain the above objectives of the invention, the disc discriminating apparatus of the present invention includes a loading mechanism disposed at an entrance of a disc drive, which can transport discs into or out of the disc drive; a sensor unit disposed close to the loading mechanism, which can start or stop the loading mechanism according to the detection; a limiting pin disposed at the center of the receptor and two symmetric positioning posts disposed at two ends of the receptor for positioning automatically; and the limiting unit is disposed on the moving way of the limiting pin, which is used to limit the moving distance of the receptor via a limiting block based on the disc size discriminated by the sensor unit.

The steps of the disc discriminating method of the present invention are as following. First, detect a disc being loaded into the disc drive, and start accordingly to draw the disc as soon as detecting a disc being loaded; count sensors on and the loading time of the disc at the same time for judging increases or decreases, judge the disc to be minor based on decrease, or judge whether the loading time of the disc is more than the predetermined time; if so, the disc is identified to be minor; if not, judging whether a predetermined number of sensors act; return to step (2) if not and then repeat the steps again; if so, judge the disc to be major. When the disc discriminating method of the invention is used for selecting proper discs, if the disc is judged to be major, the loading is finished, and if the disc is judged to be minor, a step of returning discs is started and the disc, which enters the returning mechanism in the opposite direction, will be returned.

### BRIEF DESCRIPTION OF THE DRAWINGS

FIG. 1 is the top view illustrating a small-size disc loading of a conventional slot-loading disc drive.

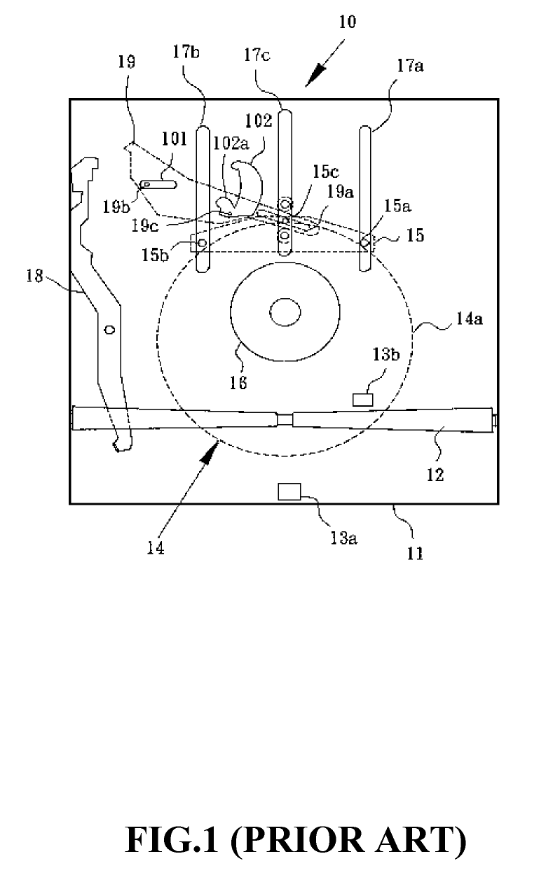

FIG. 2 is the top view illustrating a big-size disc loading of a conventional slot-loading disc drive.

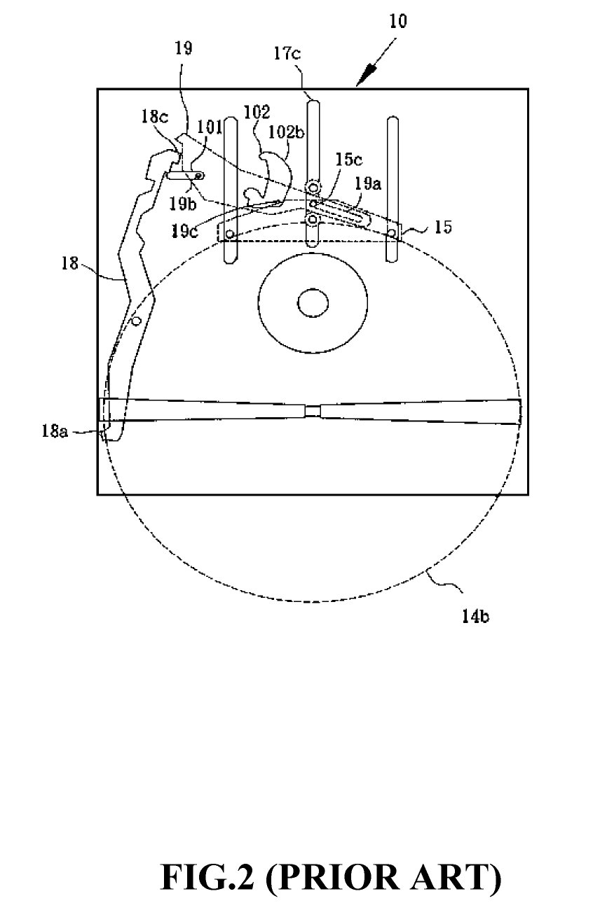

FIG. 3 is the top view illustrating the disc loading of the disc drive of the present invention.

FIG. 4 is the flow chart of the disc discriminating method of the present invention.

FIG. 5 is the flow chart of selecting discs with the disc discriminating method of the present invention.

### DETAILED DESCRIPTION OF THE INVENTION

The technical means for the above objectives and the effectiveness will be explained in the following detailed description with the preferred embodiment and together with the attached drawings.

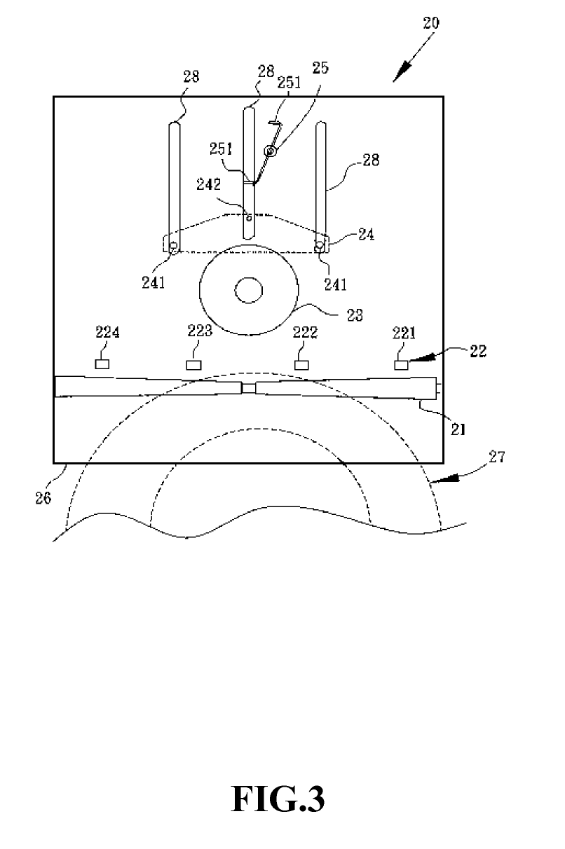

The disc discriminating apparatus of the present invention applies to a slot-in disc drive and an extra disc loading module etc. The disc drive with slot-in roller is taken as an example referred to FIG. 3, the disc drive 20 mainly includes a disc loading mechanism such as a roller 21, a sensor unit 22, a spindle motor 23, a disc receptor 24, and a limiting unit 25. The roller 21 is disposed transversely at the entrance 26 of the disc drive 20. The sensor unit 22 can be a sensitized sensor, a limit-switch sensor and so on, which are made up of a plurality of sensors 221, 222, 223, and 224, which are disposed in a row adjacent to the roller 21 and near the entrance 26. In the preferred embodiment, the sensor unit 22 is disposed behind the roller 21, which can start or stop the roller 21 rotating at the right moment according to the detection.

Besides, the spindle motor 23 is disposed near the center of the disc drive 20. The receptor 24 is disposed near the back of the spindle motor 23. Two symmetric center positioning posts 241 for the spindle motor 23 are disposed on the two ends of the receptor 24. A limiting pin 242 is disposed at the center of the receptor. Three strip runners 28 are disposed in parallel along the disc 27 loading direction at the back of the spindle motor 23 of the disc drive 20. Two positioning posts 241 and the limiting pin 242 are made to slide in the three strip runners 28, so that the receptor 24 can move along the loading direction of the disc 27. The limiting unit 25, which is disposed next to the runner 28, is for the limiting pin sliding to limit the moving distance of the receptor 24 selectively with the limiting block 251 based on the disc size discriminated by the sensor unit 22.

Therefore, the sensor unit 22 detects the loading of the disc 27 and the disc size, the disc drive 20 accordingly drives the roller 21 rotating to draw the disc 27, and determine the proper limiting block 251 of the limiting unit 25. The center positioning posts 241 of the receptor 24 support the back edge of the disc 27 to make it aim to the central line of the spindle motor 23 automatically. Guided by the runner 28, the receptor 24 moves backwards in a distance limited by the limiting unit 25 to make the disc 27 reach the spindle motor 23 and complete the positioning. When ejecting a disc, the disc drive rotates the roller 22 reversely to send out the disc 27 until the action number of the sensor 221, 222, 223, and 224 decreases to the predetermined number, and then stops the roller 22 rotating and leaves the disc 27 lodged at the entrance 26 to be taken away.

The disc discriminating apparatus of the present invention discriminates the disc size via a sensor unit to replace a conventional multi-linkage disc discriminating mechanism, so as to avoid the space for long linkage operation and the height for piling, the disc drive is effectively made thinner, the cost price of production is decreased, and the efficiency of assembly is promoted.

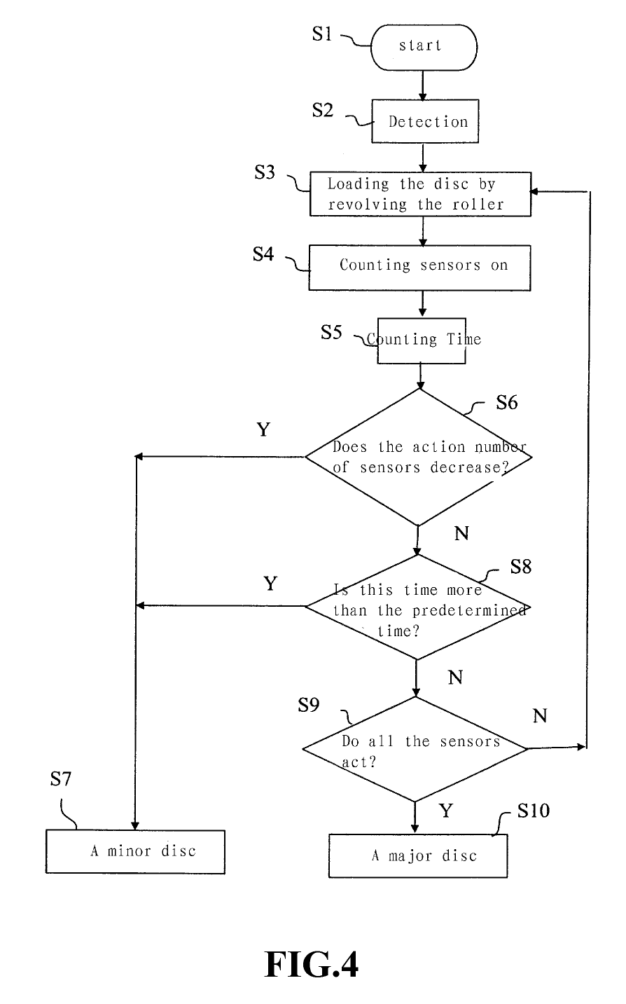

As shown in FIG. 4, the method for discriminating the disc of the present invention starts with step S1: loading the disc 27 into the disc drive 20. The sensor unit 21 performs step S2: detecting. When any of the sensors 221, 222, 223 and 224 begins to act, the roller 22 is immediately driven to draw the disc 27 into the disc drive with step S3 of rotating the roller 22. Simultaneously, count the action number of the sensors in the sensor unit 21 with the number counting step S4, and start to count the time with the time counting step S5 to record the loading time of the disc into the disc drive, which is followed by step S6 of judging the action number of sensors to determine the disc size based on the facts that discs with different sizes have different diameters and the numbers of sensors covered also differ when the discs with different diameters pass through. If more sensors are used, it will increase the types of disc sizes that can be discriminated, but the cost price of elements will be increased accordingly. In the preferred embodiment, four sensors are disposed to discriminate a disc with 8 cm diameter and a disc with 12 cm diameter. The 8 cm disc can cover three sensors, whereas the 12 cm disc can cover four sensors. Thus, the action number of sensors will increase continuously after the mechanism is driven. Once the action number of sensors is detected to decrease, the disc can be judged to be a minor disc, that is, an 8 cm disc, according to step S7. Otherwise, step S8 is started for comparing the loading time of the disc with the predetermined time. Since a disc can cover the distance of all the chord length of sensors, the loading time of a disc can be worked out on the condition that the rotating rate of the roller 22 is constant. The loading time in this embodiment is approximately 0.3 second. If all the sensors are not covered after the predetermined time passes, the disc can be judged to be a minor disc according to step S7. If the loading time is no more than the predetermined time after comparison, the next step S9 is started to judge whether all sensors act, i.e. all sensors are covered. If all sensors are covered, the disc can be judged to be a major disc, that is, a 12 cm disc, according to step S10. Otherwise, step S3 is repeated to drive the roller 22 rotating to continue drawing the disc 27.

Therefore, the disc discriminating method of the present invention has two procedures on the loading time of discs and the change of action number of sensors for discriminating the disc size. The crossed methods can be used to discriminate the disc size quickly and prevent discs from touching the discriminating mechanism by mistake, so that the disc drive can respond to the size of loaded discs quickly and properly to promote the reliability.

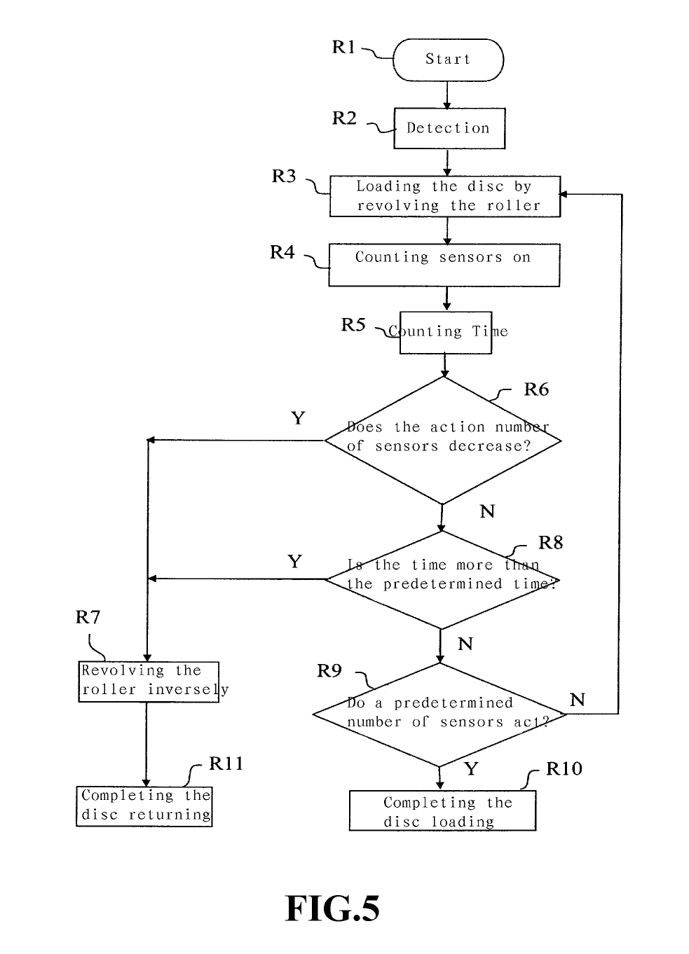

Besides, as shown in FIG. 5, the disc discriminating method of the present invention can also be used in a disc drive for selecting discs with proper sizes. The starting step R1, detection step R2, step R3 for rotating the roller, step R4 of number counting, step R5 of time counting, step R6 of judging the action number of sensors decreasing, and step R8 of comparing the loading time of discs with the predetermined time. They are all same as the processes and methods in step S1 to S8, which the disc discriminating method mentioned above. The difference is that when the action number of sensors decreases in step R6 or the counted time is more than the predetermined time in step R8, step R7 is started to drive the roller rotating inversely and return the disc to complete returning step R11. On the contrary, if the action number of sensors does not decrease in step R6 and the loading time of the disc is not more than the predetermined time, step R9 is started to judge whether a predetermined number of sensors act, i.e. a predetermined number of sensors are covered. The predetermined number of sensors should be determined properly according to the disc size and the density of sensors disposed. If a predetermined number of sensors are not covered, return to step R3 and continue rotating the roller to draw the disc. If a predetermined number of sensors are covered, the disc is loaded completely according to step 10.

As for a disc drive with discs in specific sizes, the disc discriminating method of the present invention can be used to eject improper discs or non-disc objects loaded by mistake quickly when the disc drive is selecting the size of discs, in case the improper disc is lodged in the disc drive to damage both the disc drive and the disc. Thus the disc drive and the disc can be protected.

The above statements are to explain the preferred embodiment of the present invention, but not to put any restriction on the invention. Therefore, any modification or variation made for the same purpose would still be in the scope of the present invention.

What is claimed is:

1. A method for discriminating discs, which applies to a slot-loading disc drive with a plurality of sensors, the steps comprising:
(1) detecting the loading of a disc into a disc drive;
(2) starting to draw the disc as soon as the disc begins to be loaded;
(3) counting sensors on;
(4) judging the action number of sensors; if the action number of sensors decreases, the disc will be discriminated to be minor; if not, taking to the next step;
(5) judging whether a predetermined number of sensors act; if not, returning to step (2) and repeating the steps, if so, taking the to next step; and
(6) discriminating the disc to be major.

2. The method for discriminating discs of claim 1, wherein loading the disc will be started with any of the sensors beginning to act after detecting the disc loaded in the disc drive.

3. The method for discriminating discs of claim 1, wherein the disc drive further includes a roller to draw the disc with the roller rolling.

4. The method for discriminating discs of claim 1, wherein step (3) of counting sensors on further includes a step of counting time to count the time of the disc loading.

5. The method for discriminating discs of claim 4, wherein a step (4-1) is further included after step (4) of judging whether the action number of sensors decreases, judging whether the disc loading time is more than the predetermined time by comparison; if so, judging the disc to be minor; if not, taking to the next step.

6. The method for discriminating discs of claim 1, wherein the predetermined number of sensors is the sensors disposed in the disc drive.

7. The method for discriminating discs of claim 1, wherein the major disc is a disc with 12 cm diameter and the minor disc is a disc with 8 cm diameter.

8. The method for discriminating discs of claim 1, wherein when the disc is judged to be minor, a step of starting to return the disc will start to return the disc.

9. The method for discriminating discs of claim 8, wherein the disc drive further includes a roller which starts rolling reversely when ejecting a disc.

10. The method for discriminating discs of claim 1, wherein when the disc is discriminated to be major, the disc loading is completed.

11. An apparatus for discriminating discs, which is disposed in a slot-loading disc drive with an entrance, including:
a loading mechanism disposed at the entrance for transporting the disc into and out of the disc drive;
a sensor unit comprising a plurality of sensors, disposed at the entrance and close to the loading mechanism, which can start or stop the loading mechanism at the right time according to the detection;
a receptor disposed at the back of the disc drive, of which two symmetric positioning posts disposed on two ends and a limiting pin disposed at the center; and
a limiting unit, disposed in the way of the limiting pin, having at least one limiting block for limiting the moving distance of the receptor.

12. The apparatus for discriminating discs of claim 11, wherein a plurality of sensors is disposed at the entrance in a row.

13. The apparatus for discriminating discs of claim 1, wherein the plural number of sensors is four.

14. The apparatus for discriminating discs of claim 11, wherein the sensor unit can be sensitized sensors or limit switches.

15. The apparatus for discriminating discs of claim 11, wherein the loading mechanism is a roller and the sensor unit is disposed behind the roller.

16. The apparatus for discriminating discs of claim 11, wherein three strip runners are disposed in parallel along the disc loading direction in the disc drive making the two positioning posts and the limiting pin slide in the three strip runners, and the limiting unit is disposed by the runner of the limiting pin.

17. The apparatus for discriminating discs of claim 11, wherein the limiting unit limits the moving distance of the receptor with the limiting block according to the disc size discriminated by the sensor unit.
